(19) United States
(12) Patent Application Publication
(10) Pub. No.: US 2015/0132590 A1
(43) Pub. Date: May 14, 2015

(54) Active Corrosion Protection Coatings

(71) Applicants: Vrije Universiteit Brussel, Brussels (BE); Universite Libre de Bruxelles, Bruxelles (BE)

(72) Inventors: Iris De Graeve, Brussels (BE); Herman Terryn, Brussels (BE); François Reniers, Bruxelles (BE); Caroline De Vos, Hoeilaart (BE); Alexandros Kakaroglou, Brussels (BE); Bernard Nisol, Brussels (BE); Bruno Van Mele, Brussels (BE); Guy Van Assche, Brussels (BE); Gill Scheltjens, Brussels (BE)

(21) Appl. No.: 14/399,365

(22) PCT Filed: May 7, 2013
(86) PCT No.: PCT/EP2013/059496

§ 371 Date: Nov. 6, 2014

(30) Foreign Application Priority Data
May 7, 2012 (DE) 12166997.2

(51) Int. Cl. C23F 11/02; C23F 13/00; C23F 13/02; B05D 1/00

(52) U.S. Cl. CPC C23F 11/02; B05D 1/62; C23F 13/005; C23F 13/02
USPC 428/457; 427/489; 427/488

(57) ABSTRACT

The present invention is related to a method for protecting a metal substrate against corrosion comprising the step of: —generating a plasma in a gaseous medium by means of a plasma device; —placing the substrate in contact with the plasma, or in a post-plasma area of said plasma; —introducing in said plasma or in said post-plasma area a corrosion inhibitor along with an organic precursor, thereby depositing a barrier layer comprising the corrosion inhibitor, the deposited layer protecting the metal substrate against corrosion.

### FIELD OF THE INVENTION

The present invention is related to a method for coating metal for protecting them against corrosion. The present invention is also related to the coated metal obtained by the method of the invention.

### STATE OF THE ART

Depending on the application various properties are required from metal surfaces, such as durable corrosion resistance, adherence, stable & aesthetic optical appearance, reflectivity, hydrophobic/hydrophilic, self-healing, anti-fungal, self-cleaning, mechanical surface resistance & flexibility, and possibly others.

The creation of these properties is based on the fundamental understanding of the physical phenomena behind them. For example, durable corrosion protection of a metal can be obtained by shielding it from the environment by a good adhering coating with excellent and durable barrier performance (i.e. no diffusion of water to the metal interface), and ideally—when the coating is damaged somehow—also showing corrosion inhibiting activity through self-healing inhibitor release to re-passivate the underlying metal.

To create or enhance such properties the metal surface undergoes various surface treatments. For most applications, conventional surface processing involves cleaning, etching, metal activation, conversion, primer application before the ultimate finish (mostly painting).

The conventional and still mostly used processing route is long and arduous involving a wide selection of wet chemicals (alkaline and acid), including often still toxic chromium containing species for corrosion inhibition, as well as volatile organic solvents for organic coatings.

In response to this long, sequential processing route involving ecological issues, various alternatives are currently used. Firstly, to avoid the organic solvent issues, waterborne systems are widely accepted. Examples are acrylic and latex based coatings. Secondly, instead of surface conversion followed by a primer, the development of combined systems is quite advanced. An example is silane coating.

Commercial silane solutions are waterborne and do not contain monomer species, therefore, they are considered environmentally sound. Although good alternatives for certain applications and properties, these systems still have their own set of problems. For one, the waterborne systems are much inferior for corrosion protection. The water in the coating is the culprit, as it is one of the essential ingredients for corrosion. Evacuation of the water during polymerisation is not always complete. Aside from poor corrosion properties, this also results in a poorly reticulated coating and can cause problems when the coated metal is exposed to freezing temperatures. Additionally, there are still many separate processing steps involved.

There is a wide interest for developing new multifunctional coatings on metals. The state of the art of research indicates that technologies to deposit ‘mono’functional coatings are known. Some examples: self-cleaning coatings using TiO₂, antibacterial using metal nanoparticles (mostly Ag), barrier properties against gas or liquid permeation using SiOₓ, SiN_{X} or silane coatings, hydrophobic surfaces using fluorinated coatings, non (bio)fouling using plasma-polymerised polyethylene glycol (pp-PEG).

The search for advanced coatings leads to the proposal to synthesize mixed coatings (hybrid coatings) that can combine at least two crucial functional properties in response to the growing demands of the industrial application.

At present, the concept is mostly investigated through wet deposition of waterborne organics mixed with, for example, inorganic nanoparticles, metal ions or other active species.

The addition of corrosion inhibitors to coatings has been a known practice for several decades. However in the prior art, mainly chromium VI (which turned out to be a highly carcinogenic species) was used to obtain self-healing properties.

The working mechanism of inhibitor bearing coatings is based on the corrosion inhibitors being released when the coating is locally damaged, and immediately passivating the metal at the damage site.

Inhibitors are generally classified as anodic-inhibiting the anodic reactions in a corrosion process- or cathodic-inhibiting the cathodic reactions in a corrosion process. So-called multifunctional inhibitors have the ability to inhibit both.

### AIMS OF THE INVENTION

The present invention aims to provide a method for coating a metal substrate for reducing corrosion. More particularly, the method of the invention aims to reduce the number of steps needed to obtain metal item protected against corrosion.

The creation of multifunctional surfaces on metals in an ecologically acceptable way, through an efficient processing is also an aim of this project.

The method of the invention further aims to suppress the need for use of hexavalent chromium in the treatment of metal surfaces.

More generally, the method of the invention aims to replaces the separate conventional wet pre-cleaning, activation, conversion and primer procedures used in prior art for protecting metal item against corrosion.

### SUMMARY OF THE INVENTION

The present invention is related to a method for protecting a metal substrate against corrosion comprising the step of:
generating a plasma in a gaseous medium by means of a plasma device;
placing the substrate in contact with the plasma, or in a post-plasma area of said plasma;
introducing in said plasma or in said post-plasma area a (precursor of a) corrosion inhibitor along with an organic precursor, thereby depositing a barrier layer comprising the corrosion inhibitor,
the deposited layer protecting the metal substrate against corrosion.

By corrosion inhibitor, it is meant a chemical species which by depositing, absorbing, adsorbing, bonding or reacting with a metal surface, inhibit anodic and/or cathodic electrochemical reactions to occur, which otherwise would result in the unwanted oxidation of the metal.

According to particular preferred embodiment the method of the invention further comprises one or a suitable combination of at least two of the following features:
the method further comprises the step of introducing in said plasma or in the post-plasma area the organic precursor of the organic barrier material without corrosion inhibitor, thereby depositing a barrier layer without corrosion inhibitor, said barrier layer without corrosion inhibitor being deposited prior to the layer comprising the inhibitor;
the organic precursor is selected from the group consisting of silanes, silicon containing monomers (HMDSO, TEOS, . . . ) styrene, bisphenol A, butadiene, alpha olefin, and halogenated alpha olefin;
the organic precursor comprises monomers selected from the group consisting of (meth)acrylate, alkane, alkene;
the organic precursor comprises at least one ethylenically unsaturated group selected from group consisting of (meth)acrylate, vinyl of allyl group;
the organic precursor comprises allyl methacrylate;
the corrosion inhibitor exhibit both cationic and anionic corrosion inhibition properties;
the (precursor of the) corrosion inhibitor comprises an organometallic compound;
the (precursor of the) corrosion inhibitor comprises phosphate groups;
the (precursor of the) corrosion inhibitor comprises a rare earth metal salt such as Cerium or Li;
the (precursor of the) corrosion inhibitor is Cerium dibutylphosphate;
the (precursor of the) inhibitor comprises (consists of) an organic compound, preferably comprising at least one azole group such as benzotriazole;
the substrate is Aluminum;
the metal substrate does not comprise a conversion layer;
the corrosion inhibitor is added gradually, thereby creating a concentration gradient of the corrosion inhibitor in the coating;
an additional layer is deposited after the barrier layer comprising the corrosion inhibitor, said additional layer being essentially free of corrosion inhibitor;
the corrosion inhibitor is gradually introduced and/or removed from plasma thereby creating a concentration gradient of the corrosion inhibitor in the coating;
the plasma is an atmospheric plasma, preferably between 100 hPa and 1200 hPa;
the plasma is a cold plasma
a carrier gas such as a noble gas is injected in the plasma, preferably Helium, Nitrogen or Argon, more preferably Argon.

Another aspect of the invention is related to metal item comprising a corrosion inhibiting coating comprising:
a first cross linked polymeric layer essentially free of corrosion inhibitor;
a second cross linked polymeric layer comprising a corrosion inhibitor.

Preferably, said metal item is obtained by the method of the invention.

According to particular preferred embodiment the method of the invention further comprises one or a suitable combination of at least two of the following features:
the first and second polymeric layers comprises plasma polymerised polymers selected from the group consisting of poly(meth)acrylate, polyalkene;
the first and second polymeric layers comprises plasma polymerised poly(allyl methacrylate);
the corrosion inhibitor exhibit both cationic and anionic corrosion inhibition properties;
the corrosion inhibitor comprises an organometallic compound;
the corrosion inhibitor comprises phosphate groups;
the corrosion inhibitor comprises at least one salt of a rare earth metal such as a salt of Ce or Li;
the corrosion inhibitor is Cerium dibutylphosphate or a plasma derivative thereof;
the substrate is Aluminum;
the metal substrate does not comprise a conversion layer;
an additional layer free of corrosion inhibitor is present on top of the layer comprising the corrosion inhibitor
the interface(s) between the polymeric layers exhibit gradual composition profiles (i.e. the composition profile does not comprise step function).

### BRIEF DESCRIPTION OF THE DRAWINGS

FIG. 1 represents a cross section of an example of coating according to the invention.

FIG. 2 represents the plasma reactor used in the examples (a) side view and (b) top view.

FIG. 3 represents the atomizer used in the example 2.

FIG. 4 represents the feed gas circuit used in the examples.

FIG. 5 represents an SVET mapping of the metal of example 2(Tip-sample distance: 100 μm, 0.05M NaCl solution, map size˜ 1200×1000 μm2, Color scale: μA/cm2).

FIG. 6 represents impedance spectra the example 1 and 2 after 3 hours of immersion in 0.1M NaCl.

FIG. 7 represents impedance spectra the example 1 and 2 before and after (1 h after) the creation of an artificial scratch.

FIG. 8 represents impedance spectra the example 1 and 2 before and after the creation of an artificial scratch, the sample being then immersed in 0.1M NaCl after respectively 1 h, 3 h and 23 h.

FIG. 9 represents impedance spectra of scratched coatings on aluminium AA2024 substrate (examples 1, 3 and 4) after 3 hours of immersion in 0.1M NaCl solution. Bare substrate is represented by plot “no coating”.

### DETAILED DESCRIPTION OF THE INVENTION

The present invention is related to a method for protecting metal surfaces against corrosion. In the present invention, an organic coating is performed by a (cold) atmospheric plasma (co-)deposition based on more than one precursor or species: at least one barrier polymer precursor and at least one corrosion inhibitor.

In the field of surface treatment of metallic substrate, a conversion layer is a layer which transforms the metal oxide film into a thin passive film with a thickness of less than 0.1 μm. This passive film consist of oxides and or salts and are formed in a solution by a chemical or electrochemical deposition reaction.

By cold plasma, or non-thermal plasma, it is meant in the present invention a partially ionized gas comprising electrons, ions, atoms, molecules and radicals out of thermodynamic equilibrium characterized by an electron temperature significantly higher than the neutral and ionic species temperature. Preferably, in the present invention, the ionic and neutral temperature (i.e. macroscopic temperature) is lower than 400° C. Advantageously, said neutral and ionic species temperature is lower than 150° C. Ideally, the temperature of neutral and ionic species in the plasma is minimized, lower than 100° C. and/or close to room temperature. The minimization of the temperature of the neutral and ionic species has the technical effect of maintaining large molecular species in the plasma, thereby having a better control of the chemical nature of the deposited layer.

The plasma is also preferably an atmospheric plasma. Advantageously having a pressure comprised between about 1 hPa and about 2000 hPa, preferably between 100 and 1200 hPa, with other ranges obtainable by combining any above specified lower limits with any above specified upper limits being as if explicitly herein written out.

At atmospheric pressure, both the fundamental scientific mechanisms and the required technology are different than for vacuum plasma. Due to the collision impact in the gas phase with electrons or molecules, one deals mostly with radicals and a huge number of fragments. As a consequence, the polymerisation mode is mostly radical-based, with a high degree of cross-linking, leading to potentially very dense polymers, which are of potential interest for good barrier properties, even for very thin coatings.

The final quality of a coating strongly depends on the deposition process itself. Plasma techniques present the advantage that cleaning, activation/functionalisation, deposition and crosslinking can be done “in-situ”, without the requirement of organic solvents or aggressive chemicals.

As it will be shown in the example, the use of low-temperature atmospheric plasma conditions surprisingly maintain the corrosion protective effect of the organometallic inhibitor to be used.

Advantageously, the inhibitor is deliberately located near the metal film interface at a volume concentration much lower than in traditional inhibitor-bearing coatings. This low concentration permits to reduce the consumption of expensive chromium-free ecofriendly inhibitors. As a limited concentration of inhibitor is enough to passivate the metal when a coating is locally damaged, there is no need to distribute the inhibitor throughout the coating thickness. Using atmospheric plasma co-deposition, the inhibitor can be part of a gradient structured coating.

When aluminium is the substrate, the inhibitor is advantageously selected from the group consisting of silicates, phosphates, rare earth metal salts such as CeCl3, Ce(NO3)3, Ce(dbp)3, Ce(dpp)3, La(NO3)3 and Pr(dbp)3, 2,5-dimecapto-1,3,4-thiadiazole, aliphatic mono- and dicarboxylic acids (C6-C10) and a primary aromatic amide, Mercaptobenzothiazole, Mercaptobenzimidazole, Mercaptobenzimidazolesulfate, thiosalicylic acid, quinaldic acid, salicylaldoxime, 8-hydroxyquinoline, Tetrachloro-p-benzoquinone, tannins, and their mixture.

When the substrate is steel, the inhibitor is advantageously selected from the group consisting of silicates, nitrites, phosphates, polyphosphates, phosphonates, rare earth metal salts such as erbium triflates, molybdates, tungstenates, vanadates, zinc cations, borates, tannins, cinnamic acids, alkanoleamines and their mixture.

When the substrate is galvanized steel (and/or zinc), the inhibitor is advantageously selected from the group consisting of silicates, phosphates, molybdates, tungstenates, vanadates, zinc cations, strontium cations, bismuthiol, polycarboxylates, hydroxyl substituted mono- and polyamine, imino derivatives, hydroxylamine derivatives, aliphatic mono- and dicarboxylic acids (C6-C10, such as hexaonic acid) and a primary aromatic amide (such as benzamide), organophosphorous such as 2-phosphonobutane-1,2,4-tricarboxylic acid), polyethylene glycol, tannins and their mixture.

For example, cerium is mined in China and its price has drastically increased once its corrosion-inhibition activity was discovered and published in scientific literature.

Preferably, in order to improve adhesion, And to reduce total consumption of inhibitor, the concentration at the interface between the metal and the coating is preferably reduced. The concentration of the inhibitor is then increased with the distance to the metal interface. The maximum concentration occurs advantageously at a distance to the interface comprised between 1 and 50 nm, preferably between 5 and 25 nm.

As the distance to the metal interface further increases, the concentration of the inhibitor is the advantageously gradually decreased down to zero. This additional barrier layer on top of the active layer reduces the leaching of the inhibitor outside the structure, thereby reducing the total amount of inhibitor used in the structure.

An advantageous feature of plasma co-deposition for producing such structure, is that the gaseous composition feeding the plasma can be dynamically controlled, the time variation of the species concentration determining the spatial gradient in the deposited material.

An advantage of the use of cold plasma, is that it has only limited influence on the intended structure of the inhibitor. This is particularly true when organic or organometallic structures are used.

Preferably, multifunctional corrosion inhibitor are used, with functional groups acting on the cathodic processes and other functional groups acting on the anodic processes.

Known functional groups acting on the cathodic processes are for example rare earth metal salts such as Ce.

Known functional groups acting on the anodic processes are for example phosphate groups.

Advantageously, for the protection of aluminium, Cerium dibutyl phosphate (Ce(dbp)₃) having formula:

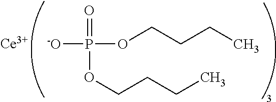

is used. In this inhibitor, Cerium is active against cathodic corrosion processes and phosphate against the anodic corrosion processes.

The (precursor of the) inhibitor can be introduced in the plasma as a gas, or liquid phase. In case of liquid phase, the introduction can advantageously be performed by spaying an aerosol of liquid droplets directly in the plasma or in a post-plasma area.

The aerosol can preferably comprise an organic solvent and the corrosion inhibitor. This is particularly advantageous when the corrosion inhibitor is solid at ambient temperature, and is soluble in a particular organic solvent. For example, Ce(dbp)₃ can be dissolved in dissolved in a methanol:hexane solution.

As a barrier polymer precursor, saturated or unsaturated hydrocarbon (eventually halogenated) can be used. Such precursors give rise to highly hydrophobic coatings preventing water diffusion towards the metal interface.

Preferably, compounds comprising at least one ethylenically unsaturated group can be used. Advantageously, allyl methacrylate is used as the precursor of the organic barrier material. Such precursor produces an efficient organic-based primer type coating exhibiting a good adhesion to the metal substrate and significant barrier properties.

The gradient type coatings according to the invention have shown good adhesion, barrier properties and an autonomous corrosion healing ability by active corrosion inhibitors that passivate the metal in case of coating damage.

### EXAMPLE

### Description of the DBD Reactor

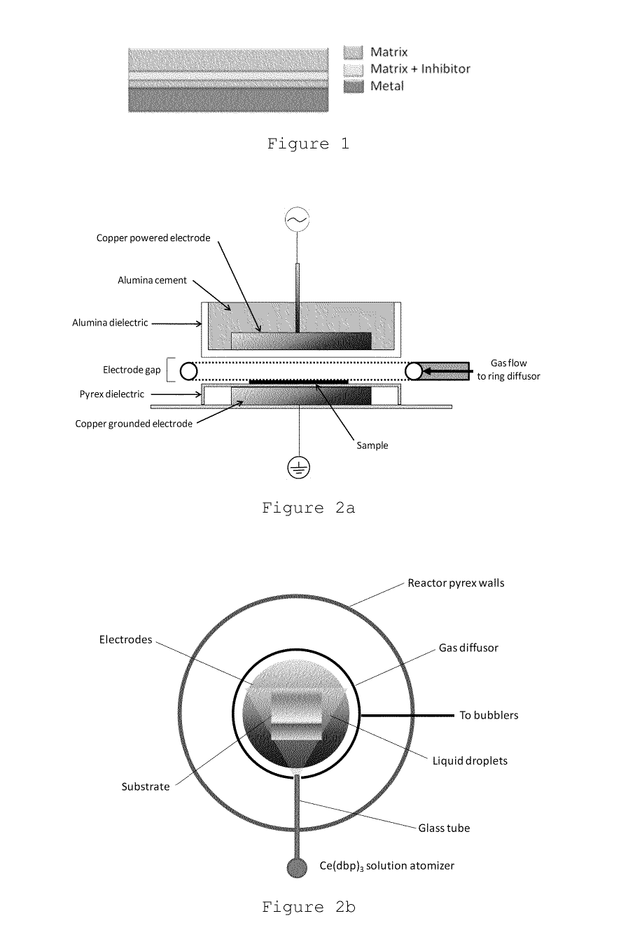

The DBD (dielectric barrier discharge) treatments were done in a plasma reactor schematically represented in FIG. 1. The top electrode of the reactor consists of a copper disc of 79 mm diameter, covered with a 3 mm thick alumina (dielectric) plate. The bottom electrode is a 79 mm copper disk covered by a 100 mm diameter, 1.5 mm thickness pyrex petri dish, acting as the second dielectric barrier. The electrode gap has been fixed to 5 mm. This DBD setup has been placed in a sealed pyrex chamber.

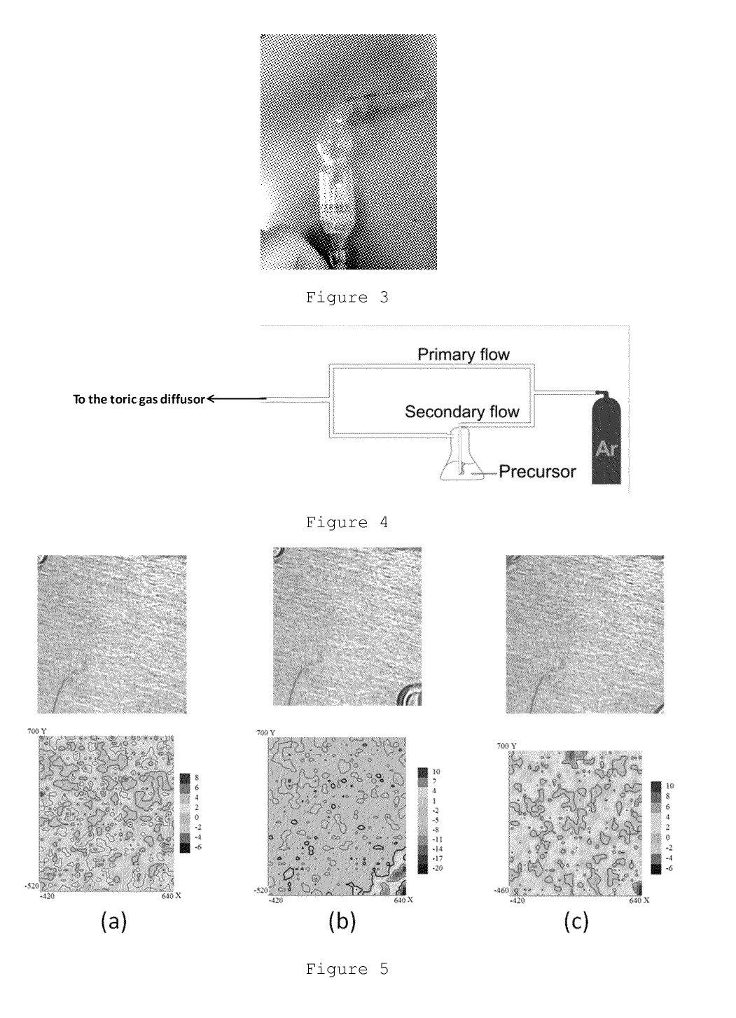

The gas injection is done using a toric gas sprinkler placed at the gap between the electrodes, outside the plasma core. The inhibitor solution microdroplets are brought in the same area by means of a glass tube linked to an atomizer as represented in FIGS. 2 and 3.

### Example 1

### Control

### Materials

Allyl methacrylate (98% purity, CAS #96-05-9, Aldrich) has been used as-received, carried by argon (Alphagaz 1, Air Liquide, plasmagen gas) directly into the discharge, during plasma treatment. The coated samples consist of mechanically polished aluminium (AA2024 alloy), 20×30 mm substrates. An AFS-G10S power generator has been used as the plasma source.

### Protocol

In order to control the monomer feed, a part of the plasma gas flow was directed through a bubbler containing allyl methacrylate at room temperature. This flow is referred to as the secondary flow (FIG. 5).

The output power was varied from 30 W to 80 W while the operating frequency was fixed to 17.1 kHz. The deposition time was set to 120 s. The total argon flow was always kept constant at 4 L/min. For these experiments, the secondary Ar flow in the bubbler was set to 1 L/min, which corresponds to a monomer feed of approximately 30 mg/min. The surface of the substrate has been pre-treated for 15 s with pure argon plasma (3 L/min) prior to the introduction of the monomer.

This protocol is summarized as follows:
i. Purging of the sealed reactor and addition of a pure argon atmosphere
ii. 15 seconds of CLEANING/ACTIVATION: pure argon plasma (argon flow=3 L/min)
iii. 120 seconds of AMA deposition: Plasma is kept on, and 1 L/min of (AMA+Argon) mixture are added (total gas flow=4 L/min)

### Example 2

### Inhibitor Solution

The corrosion inhibitor, namely cerium dibutylphosphate has been dissolved (1% weight) in a methanol:hexane (20:80) solution.

### Protocol

This follows exactly the same protocol as for the deposition of pure AMA which consists of the 15 seconds of cleaning/activation of the substrate and 120 seconds of plasma deposition of AMA. An extra step during the AMA deposition is added to the protocol, involving the inhibitor solution atomizer, and argon, used as carrying gas.

The output power was varied from 30 W to 80 W while the operating frequency was fixed to 17.1 kHz. The TOTAL deposition time was set to 120 s. For these experiments, the secondary Ar flow in the bubbler was set to 1 L/min, which corresponds to a monomer feed of approximately 30 mg/min.

After 15 seconds of the pure AMA deposition, the inhibitor solution microdroplets are carried simultaneously, by argon and through the pyrex tube, directly in the plasma discharge. The extra argon flow was set to 2 L/min, bringing the total argon flow to 6 L/min. The duration of this extra step is 45 seconds. The total amount of inhibitor solution injected in the plasma was 1 mL.

At this point, the injection of the inhibitor was stopped and followed by a 60 seconds deposition of pure AMA in order to form a protective AMA topcoat.

The surface of the substrate has been pre-treated for 15 s with pure argon plasma (3 L/min) prior to the introduction of the monomer.

This protocol is summarized as follows:
i. Purging of the sealed reactor and addition of a pure argon atmosphere
ii. 15 seconds of CLEANING/ACTIVATION: pure argon plasma (argon flow=3 L/min)
iii. 15 seconds of AMA deposition: Plasma is kept on, and 1 L/min of (AMA+Argon) mixture are added (total gas flow=4 L/min)
iv. 45 seconds of AMA+inhibitor co-deposition: Plasma is still kept on, 2 L/min of argon bringing the inhibitor solution droplets are added to the initial mixture (total gas flow=6 L/min)
v. 60 seconds of AMA deposition: Injection of the inhibitor is stopped. Plasma is kept on, and 1 L/min of (AMA+Argon) mixture are added (total gas flow=4 L/min)

The time for the deposition can be varied as desired in order to control the amount of inhibitor injected.

The thickness of the coatings of the two examples have been estimated using Spectroscopic Ellipsometry.

| | Thickness | |
|---|---|---|
| Example 1 | 370 ± 25 | nm |
| Example 2 | 430 + 20 | nm |

### Example 3

The same protocol as in example 2 was used except that the cerium dibutylphosphate inhibitor was replaced by benzotriazol inhibitor, and the inhibitor was gradually introduced and removed from the plasma, thereby creating a smooth concentration profile.

### Example 4

The same protocol as in example 3 was used, except that the inhibitor was directly injected in step iii, so that no layer without inhibitor was deposited on the substrate.

the Scanning Vibrating Electrode Technique (SVET) was used to demonstrate the corrosion inhibition activity of the coating of the example. This technique is an in-situ local electrochemical technique that allows to measure the corrosion activity above a coated metal while immersed in a corrosive electrolyte. SVET mapping of a plasma coated AA2024 surface, which is an alloy particulary prone to corrosion, shows no corrosion activity during 1 day of immersion in NaCl solution as shown in FIG. 5c. Current density values remain very low during the experiment. This is clear evidence that the presence of coating provides an effective protection to the AA2024 substrate against corrosion.

### Additional Impedance Data

Electrochemical Impedance Spectroscopy was also used to verify anti-corrosion activity of the coating. This method is well established to evaluate coatings.

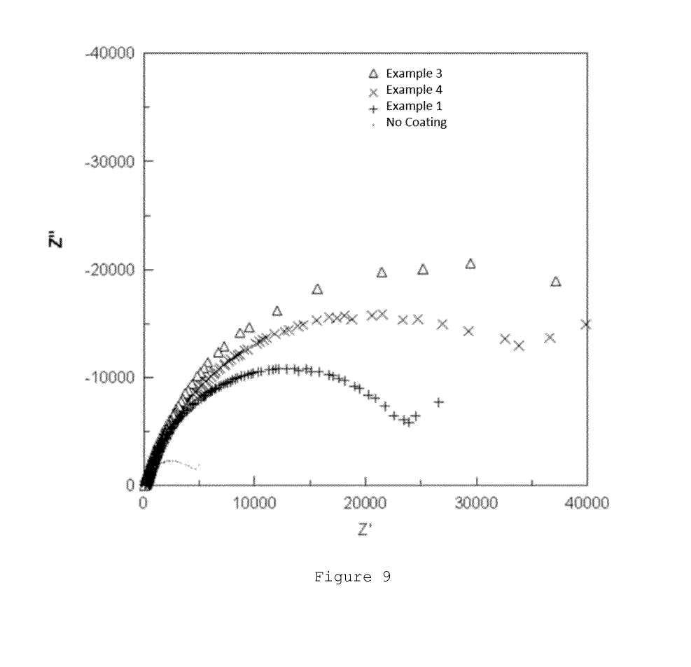

Electrochemical Impedance Spectroscopy is a characterization technique in which a small perturbation voltage over a range of frequencies is applied in an electrochemical system and the response current is measured. The impedance for each measured frequency of the system is calculated. A way to present impedance spectroscopy data is by plotting the real part of the impedance on the X-axis and the imaginary part on the Y-axis of a chart (Nyquist Plot, see FIG. 9). In a coated metal the diameter of the semicircle in the low frequencies is the sum of the polarization (Rp) and the coating resistance (Rc). In case there is a defect in the coating (Rc very small thus Rp>>Rc) the diameter of the semicircle is practically equal to the Rp.

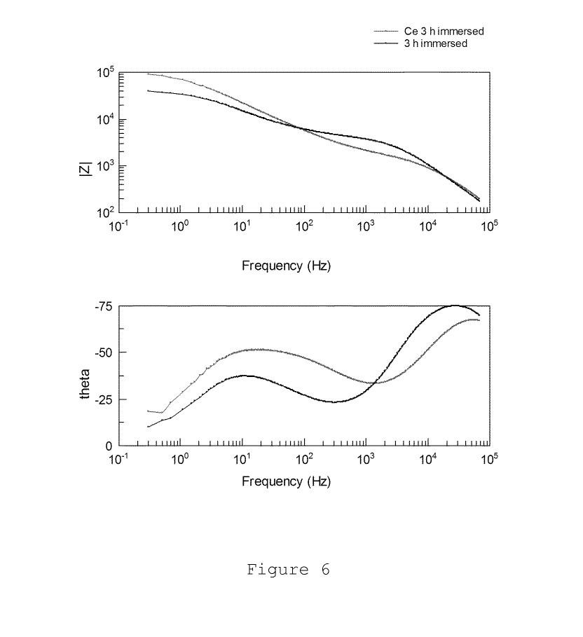

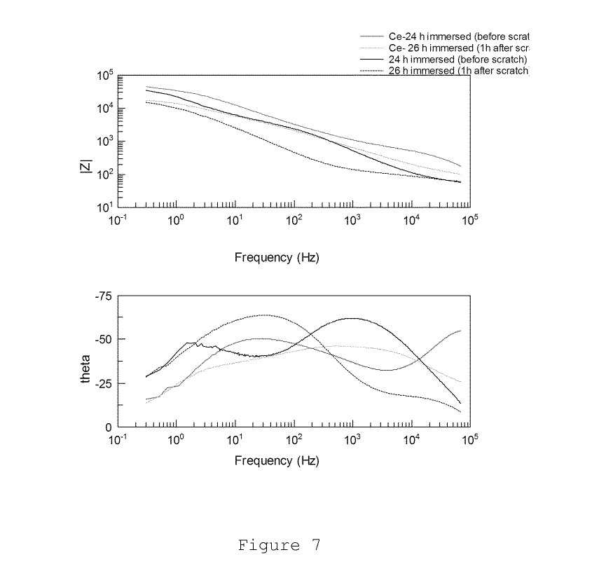

FIG. 6 shows representative impedance spectra of one coating with and one without inhibitor after three hours of immersion in NaCl 0.1 M. As shown, the impedance of the coating with inhibitor is lower at high frequencies. This is due to the lower thickness of the coating. At low frequencies, the impedance of the coating containing the corrosion inhibitor reaches the levels of 100 kOhm comparing to the 30 kOhm of the coating without inhibitor. This reproducible difference is due to the different structure and components of the coating.

### Creation of an Artificial Scratch

In order to evaluate the efficiency of the inhibitor an artificial scratch has been made in the coatings. This scratch was made in a homemade device in which the same weight was applied in all cases to achieve the same kind of scratch in all cases.

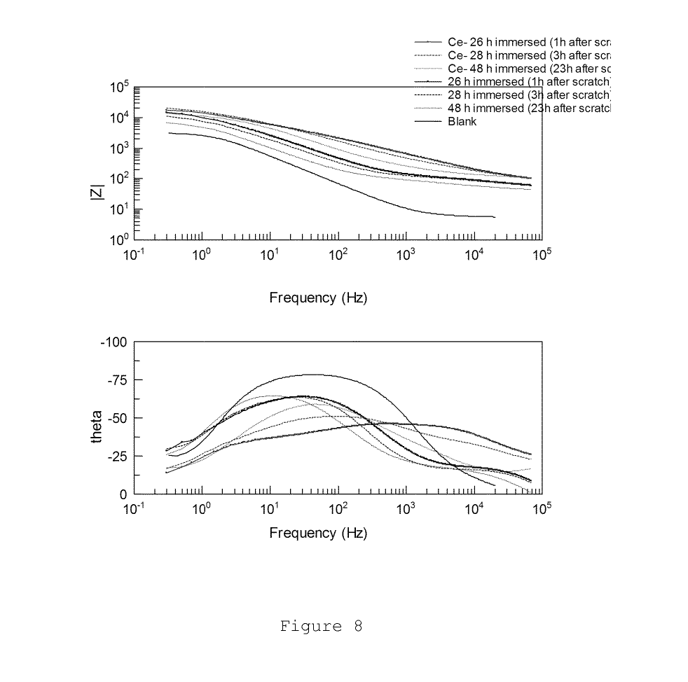

FIG. 7 shows the Impedance spectra before and one hour after the scratch. Even if the thickness of the coating with inhibitor is lower thus the scratch would reach easier the substrate, FIG. 7 shows that the impedance of the coating with inhibitor remains higher and this can be attributed to the fact that when making the scratch the inhibitor leaches out and inhibits the corrosion of the substrate.

### Evolution of the Impedance

Another two spectra were taken 3 and 23 hours after the scratch. FIG. 8 shows the evolution of the impedance. The thick line shows the impedance 1 h after the scratch, the dashed line 3 hours after the scratch and the dotted line 23 hours after the scratch. The blue lines are the spectra of the coating without inhibitor and the red ones of the coatings with inhibitor. When the inhibitor is not present the impedance continuously decreases especially at low frequencies which is the region where the slow occurring processes like corrosion manifest themselves. When the inhibitor is present the impedance increases at low frequencies 3 hours after the scratch due to the decrease of the corrosion reactions because of the corrosion inhibitor.

In order to verify the results the same measurements were performed again and the same influence of the inhibitor in the impedance was observed.

The incorporation of the Ce(dbp)₃ as inhibitor inside plasma polymerized coating provides self-healing properties to the coating. Depositing the inhibitor close to the substrate decreases the deposition cost as only a small amount of inhibitor should be used. The efficiency of the inhibitor is still high because it is located close to the substrate.

As can be seen in FIG. 9, benzotriazole (example 3 and 4) also provides self-healing properties to the coating. Furthermore, the presence of a barrier layer without inhibitor at the interface between the coating and the metallic substrate is shown to have a positive impact on the corrosion inhibition.

1. Method for protecting a metal substrate against corrosion comprising the step of:
generating a plasma in a gaseous medium by means of a plasma device;
placing the substrate in contact with the plasma, or in a post-plasma area of said plasma;
introducing in said plasma or in said post-plasma area a corrosion inhibitor along with an organic precursor, thereby depositing a barrier layer comprising the corrosion inhibitor,
the deposited layer protecting the metal substrate against corrosion wherein the corrosion inhibitor is gradually introduced in said plasma or in said post-plasma area thereby creating a concentration gradient of the corrosion inhibitor in the coating, the inhibitor concentration at the interface between the substrate and the barrier layer being lower than in the bulk of said barrier layer.

2. Method according to claim 1 wherein the corrosion inhibitor is gradually removed from plasma thereby creating a concentration gradient of the corrosion inhibitor in the coating, the inhibitor concentration at the surface of the barrier layer being lower than in the bulk of said barrier layer.

3. Method according to claim 1 further comprising the step of introducing in said plasma or in the post-plasma area the organic precursor of the organic barrier material without corrosion inhibitor, thereby depositing a barrier layer without corrosion inhibitor, said barrier layer without corrosion inhibitor being deposited prior to the layer comprising the inhibitor.

4. Method according to claim 1 wherein the organic precursor is selected from the group consisting of silanes, silicon containing monomers, styrene, bisphenol A, butadiene, (meth)acrylate, allyl methacrylate, alkane, alkene, halogenated alkane and halogenated alkene.

5. Method according claim 1 wherein the corrosion inhibitor exhibit both cationic and anionic corrosion inhibition properties.

6. Method according to claim 1 wherein the corrosion inhibitor comprises an organometallic compound.

7. Method according to claim 1 wherein the corrosion inhibitor comprises phosphate groups.

8. Method according to claim 1 wherein the corrosion inhibitor comprises a rare earth metal salt such as Cerium.

9. Method according to claim 1 wherein the corrosion inhibitor is Cerium dibutylphosphate.

10. Method according to claim 1 wherein the substrate is Aluminum.

11. Method according to claim 1 wherein the plasma is a cold atmospheric plasma.

12. Metal item comprising a corrosion inhibiting coating comprising:
a first cross linked polymeric layer essentially free of corrosion inhibitor;
a second cross linked polymeric layer comprising a corrosion inhibitor.

13. Metal item according to claim 12 wherein the substrate is Aluminum.

14. Metal item according to claim 12 wherein the metal substrate does not comprise a conversion layer.

15. Metal item according to claim 12 wherein the metal substrate does not comprise a conversion layer.
